(19) United States
(12) Patent Application Publication
(10) Pub. No.: US 2017/0090116 A1
(43) Pub. Date: Mar. 30, 2017

(54) BACKLIGHT UNIT AND DISPLAY APPARATUS INCLUDING THE SAME

(71) Applicant: Samsung Display Co., Ltd., Yongin-Si (KR)

(72) Inventor: Yeongbae LEE, Suwon-si (KR)

(21) Appl. No.: 15/158,914

(22) Filed: May 19, 2016

(30) Foreign Application Priority Data
Sep. 30, 2015 (KR) 10-2015-0138114

(51) Int. Cl. G02B 6/032; F21V 8/00

(52) U.S. Cl. CPC G02B 6/032; G02B 6/0005; G02B 6/001

(57) ABSTRACT

A display apparatus includes a display panel which displays an image and a backlight unit which provides light to the display panel. The backlight unit includes a bottom chassis, a driving substrate, a laser light source, an optical unit, and an optical fiber. The bottom chassis includes a bottom surface and a sidewall. The laser light source emits laser light to the sidewall. The optical unit has an incident surface having a first area and into which the laser light from the laser light source is incident and an emission surface having a second area less than the first area and from which the laser light is emitted. The optical fiber receives the laser light from the emission surface, an end of the optical fiber is connected to the emission surface, recessed patterns are defined on the optical fiber, and the laser light is emitted through the recessed patterns.

This application claims priority to Korean Patent Application No. 10-2015-0138114, filed on Sep. 30, 2015, and all the benefits accruing therefrom under 35 U.S.C. §119, the content of which in its entirety is herein incorporated by reference.

### BACKGROUND

1. Field

The disclosure herein relates to a backlight unit and a display apparatus including the backlight unit, and more particularly, to a backlight unit including a laser light source and a display apparatus including the backlight unit.

2. Description of the Related Art

Non-emissive display apparatuses such as liquid crystal display apparatuses, electrophoretic display apparatuses, and electro-wetting display apparatuses include a backlight unit to receive light from the backlight unit.

The backlight unit may be classified into an edge type backlight unit and a direct type backlight unit according to a position of a light source unit with respect to a display surface. A direct type backlight assembly may have a relatively inexpensive manufacturing cost when compared to that of an edge type backlight assembly because a light guide plate and a heat dissipation part typically used for an edge type light source is typically omitted. Also, the direct type backlight assembly may have an optical loss less than that of the edge type backlight assembly to obtain higher luminance under a same power condition.

The backlight unit includes a light source such as a light emitting diode and a cold cathode fluorescent lamp (“CCFL”), for example. A color space that can be displayed on the display apparatus may depend on the type of light source in the backlight unit.

### SUMMARY

The disclosure provides a backlight unit with improved color gamut and a display apparatus including the backlight unit.

According to an embodiment of the inventive concept, a display apparatus includes a display panel which displays an image and a backlight unit which provides light to the display panel. In such an embodiment, the backlight unit may include a bottom chassis, a driving substrate, a laser light source, an optical unit, and an optical fiber. In such an embodiment, the bottom chassis includes a bottom surface and a sidewall bent from the bottom surface, the driving substrate is disposed in the bottom chassis, and the laser light source is connected to the driving substrate to emit laser light to the sidewall. In such an embodiment, the optical unit includes an incident surface having a first area and into which the laser light is incident and an emission surface having a second area less than the first area and from which the laser light emitted from the laser source is emitted, and the optical fiber receives the laser light emitted from the optical unit, an end of the optical fiber is connected to the emission surface, recessed patterns are defined on the optical fiber, and the laser light is emitted through the recessed patterns.

In an embodiment, the laser light source may include first to third laser light sources which emit the laser light to the incident surface.

In an embodiment, the first laser light source may emit a red laser light, the second laser light source may emit a green laser light, and the third laser light source may emit a blue laser light.

In an embodiment, the incident surface may include first to third incident surfaces. In such an embodiment, the first incident surface may be parallel to an inner surface of the sidewall, the second incident surface may extend from a side of the first incident surface to define an internal angle, which is less than about 180°, with the first incident surface, and the third incident surface may extend from another side of the first incident surface at an internal angle, which is less than about 180°, with the first incident surface.

In an embodiment, the driving substrate may include a flat portion, a first inclined portion, and a second inclined portion. In such an embodiment, the flat portion may extend in parallel to the first incident surface, and the first laser light source may be disposed on the flat portion. In such an embodiment, the first inclined portion may extend in parallel to the second incident surface from one side of the flat portion, and the second laser light source may be disposed on the first inclined portion. In such an embodiment, the second inclined portion may extend in parallel to the third incident surface from the other side of the flat portion, and the third laser light source may be disposed on the second inclined portion.

In an embodiment, a distance between the flat portion and the first incident surface, a distance between the first inclined portion and the second incident surface, and a distance between the second inclined portion and the third incident surface may be the same as each other.

In an embodiment, the driving substrate may include first and second driving substrates. In such an embodiment, the first to third laser light sources may be disposed on each of the first and second driving substrates. In such an embodiment, the optical fiber may extend in a first direction, and the first and second driving substrates may be spaced apart from each other in a second direction crossing the first direction.

In an embodiment, the recessed patterns defined in the optical fiber may be spaced apart from each other in the first direction.

In an embodiment, the backlight unit may further include a connection substrate which connects the first and second driving substrates to each other and extends in parallel to the first incident surface.

In an embodiment, the first and second driving substrates and the connection substrate may be integrated with each other.

In an embodiment, the optical fiber may include a core through which the laser light proceeds and a cladding surrounding the core. In such an embodiment, the recessed patterns are defined by openings defined in the cladding, and the core may be exposed through the openings in the recessed patterns.

In an embodiment, a height of the emission surface in a direction perpendicular to the bottom surface is less than a height of the incident surface in the direction perpendicular to the bottom surface, and a width of the emission surface in a direction parallel to the bottom surface is less than a width of the incident surface in the direction parallel to the bottom surface.

In an embodiment, the driving substrate may be fixed to the sidewall.

In an embodiment, the driving substrate may include a base substrate and a line layer. In such an embodiment, the base substrate may include a metal and be fixed to the sidewall. In such an embodiment, the line layer may be disposed on the base substrate and include circuits and lines for driving the laser light source.

In an embodiment, the backlight unit may further include an adhesive which couples the driving substrate to the sidewall.

In an embodiment, the backlight unit may further include a screw disposed to pass through the driving substrate and coupled to the sidewall.

In an embodiment, the backlight unit may further include a support disposed between the optical fiber and the bottom surface to support the optical fiber.

According to another embodiment of the inventive concept, a backlight unit includes a bottom chassis, a driving substrate, a laser light source, an optical unit, and an optical fiber. In such an embodiment, the bottom chassis includes a bottom surface and a sidewall bent from the bottom surface, the driving substrate is disposed within the bottom chassis, and the laser light source is connected to the driving substrate to emit laser light to the sidewall. In such an embodiment, the optical unit includes an incident surface having a first area and into which the laser light emitted from the laser source is incident and an emission surface having a second area less than the first area and from which the laser light is emitted. In such an embodiment, the optical fiber receives the laser light emitted from the emission surface, an end of the optical fiber is connected to the emission surface, recessed patterns are defined on the optical fiber, and the laser light is emitted through the recessed patterns.

In an embodiment, the laser light source may include first to third laser light sources which emit the laser light to the incident surface.

According to another embodiment of the inventive concept, a display apparatuses includes a display panel which displays an image and a backlight unit which provides light to the display panel. In such an embodiment, the display panel and the backlight unit are curved on the basis of a reference axis. In such an embodiment, the backlight unit may include a bottom chassis, a driving substrate, a laser light source, an optical unit, and an optical fiber. In such an embodiment, the optical fiber is curved on the basis of the reference axis and receives the laser light emitted from the emission surface. In such an embodiment, an end of the optical fiber is connected to the emission surface, recessed patterns are defined on the optical fiber, and the laser light is emitted through the recessed patterns.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view of a display apparatus according to an embodiment of the inventive concept;

FIG. 2 is a cross-sectional view taken along line I-I′ of FIG. 1;

FIG. 3 is a plan view of a bottom chassis and a light source part according to an embodiment of the inventive concept;

FIG. 4 is a plan view of an embodiment of a light source part;

FIG. 5 is a perspective view of an embodiment of the light source part;

FIG. 6 is a perspective view of an embodiment of an optical fiber;

FIG. 7 is a cross-sectional view taken along line I-I′ of FIG. 6;

FIG. 8 is a perspective view of an embodiment of a support of FIG. 2;

FIG. 9 is a plan view of a bottom chassis and a light source part according to an alternative embodiment of the inventive concept;

FIG. 10 is a sectional view of a display apparatus according to an alternative embodiment of the inventive concept;

FIG. 11A is a perspective view of an optical unit and a reflection layer according to another alternative embodiment of the inventive concept;

FIG. 11B is a front view of the optical unit and the reflection layer shown in FIG. 11A;

FIG. 11C is a side view of the optical unit and the reflection layer shown in FIG. 11A;

FIG. 12 is an exploded perspective view of a display apparatus according to another alternative embodiment of the inventive concept;

FIG. 13 is a view illustrating intensities of red, green, and blue laser light depending on wavelengths of the laser light; and

FIG. 14 is a view of color spaces that are capable of being realized in the display apparatus adopting various light sources in a CIE1931 color space.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

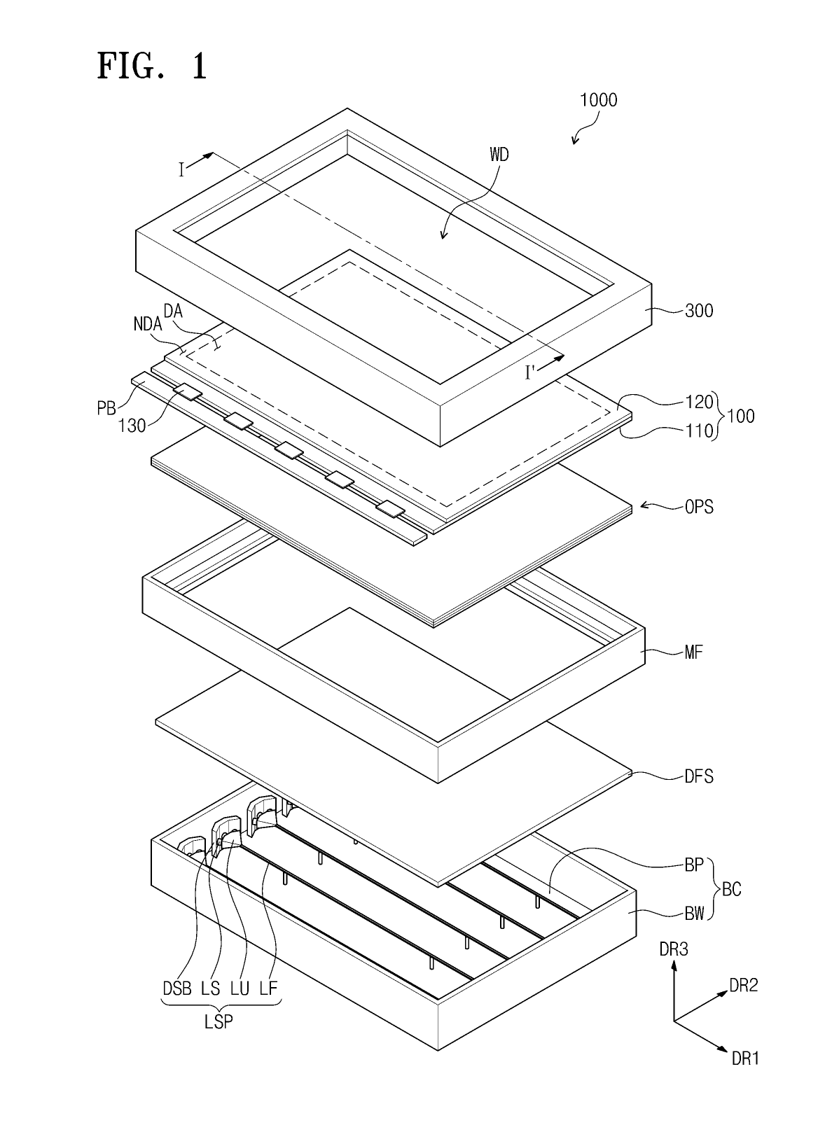

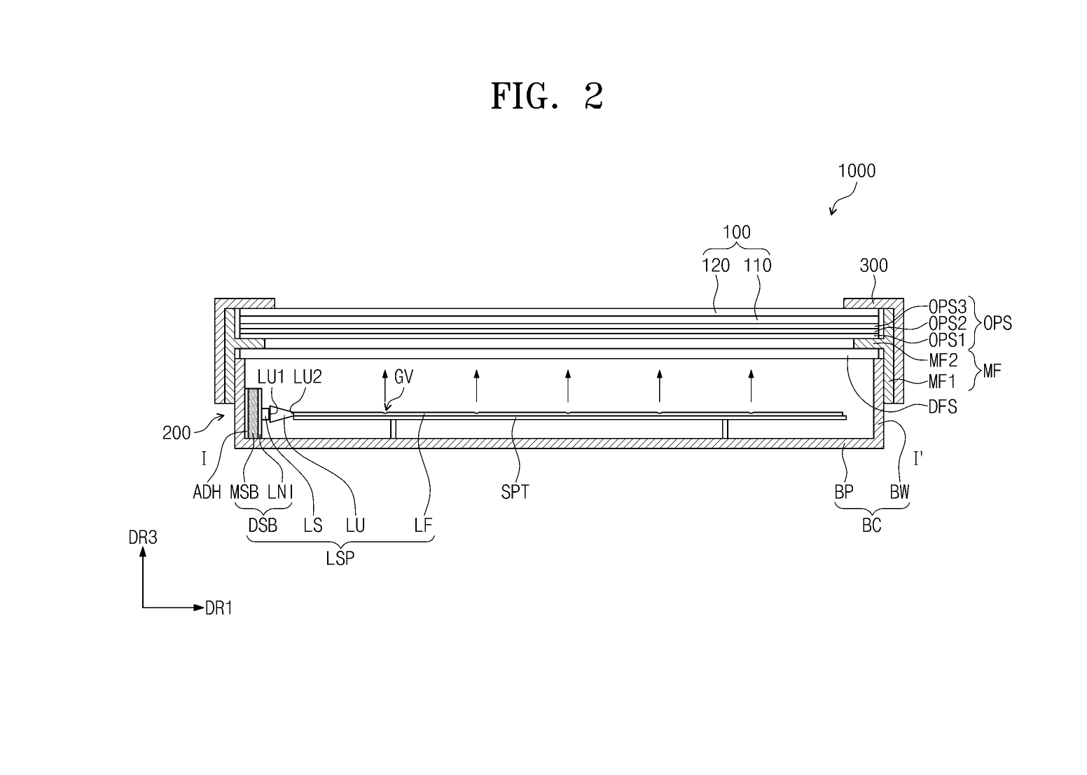

FIG. 1 is an exploded perspective view of a display apparatus according to an embodiment of the inventive concept, and FIG. 2 is a cross-sectional view taken along line I-I′ of FIG. 1.

Referring to FIGS. 1 and 2, an embodiment of a display apparatus 1000 may include a display panel 100, a backlight unit 200, and a top chassis 300.

The display panel 100 displays an image. The display panel may include a non-emissive display panel, but may not include a self-luminous display panel such as an organic light emitting display panel. The display panel 100 may include at least one of various non-emissive display panels such as a liquid crystal display panel, an electrowetting display panel, an electrophoretic display panel, and a microelectromechanical system (“MEMS”) display panel, for example. Hereinafter, an embodiment where the display panel 100 is the liquid crystal display panel will be described in detail for convenience of description.

In an embodiment of the inventive concept, the display panel 100 may have a rectangular shape when viewed from a plan view, e.g., a top plan view in a thickness direction of the display panel 100. Herein, an extension direction of each of long sides of the display panel 100 may be defined as a first direction DR1, and an extension direction of each of short sides of the display panel 100 may be defined as a second direction DR2. Also, a thickness direction of the display panel 100 may be defined as a third direction DR3.

The display panel 100 may include a first substrate 110, a second substrate 120 facing the first substrate 110, and a liquid crystal layer (not shown) disposed between the first and second substrates 110 and 120. The display panel 100 may be divided into a display area DA on which an image is displayed and a non-display area NDA on which an image is not displayed, when viewed from the top plan view. The non-display area NDA may be covered by the top chassis 300 when viewed from the top plan view.

In an embodiment, the first substrate 110 may include gate lines, data lines, a thin film transistor, and a pixel electrode. The gate lines and the data lines may be insulated from each other and may cross each other. The thin film transistor may be a three-terminal device. In such an embodiment, the thin film transistor may be connected to one gate line, one data line, and one pixel electrode. A data voltage applied to the data line may be applied to the pixel electrode in response to a signal applied to the gate line.

The second substrate 120 may be disposed on the first substrate 110. The second substrate 120 may be disposed to face the first substrate 110 with the liquid crystal layer therebetween. The second substrate 120 may include a color filter and a common electrode. However, an embodiment of the inventive concept is not limited thereto. In one alternative embodiment, for example, the first substrate 110 may include the color filter and the common electrode.

The second substrate 120 may have a size less than that of the first substrate 110 when viewed from the top plan view. A portion of the first substrate 110 may be exposed by the second substrate 120.

The liquid crystal layer may include a plurality of liquid crystal molecules, arrangements of longitudinal axes of which change according to electric fields generated between the first and second substrates 110 and 120.

The display apparatus 1000 may further include a driving chip (not shown), a driving circuit film 130, and a printed circuit board PB.

The driving circuit film 130 may be bent to electrically connect the display panel 100 to the printed circuit board PB. The driving circuit film 130 may have one end connected to a surface of the first substrate 110 exposed by the second substrate 120 and the other end connected to the printed circuit board PB.

The printed circuit board PB may output a signal to the display panel 100 or receive a signal from the display panel 100 through the driving circuit film 130. In an embodiment, as shown in FIG. 1, the printed circuit board PB is disposed in a same plane as the display panel 100, but an embodiment of the inventive concept is not limited thereto. In alternative embodiments, for example, the printed circuit board PB may be disposed at various positions according to a structure of the display apparatus 1000. The printed circuit board PB may be disposed on a lower portion or a side surface of the backlight unit 200 in an embodiment where the driving circuit film 130 is bent.

The driving chip (not shown) may receive an external signal to generate a driving signal for driving the display panel 100. The external signal may be a signal from the printed circuit board PB. The external signal may include an image signal, various control signals, and a driving voltage. The driving chip (not shown) may be disposed, e.g., mounted, on the driving circuit film 130, the printed circuit board PB, or the first substrate 110.

The backlight unit 200 may be disposed under the display panel 100 to provide light to the display panel 100.

The backlight unit 200 may include a bottom chassis BC, a light source part LSP, a diffusion plate DFS, optical sheets OPS, and a middle mold MF.

The bottom chassis BC may include a bottom surface BP and a sidewall BW.

The bottom surface BP may be flat. The bottom surface BP may have a rectangular shape when viewed from the top plan view. The sidewall BW may be bent to extend upwardly from an edge of the bottom surface BP. An accommodation space may be defined by the bottom surface BP and the sidewall BW, and the light source part LSP may be accommodated in the accommodation space.

The light source part LSP may include a driving substrate DSB, a laser light source LS, an optical unit LU, and an optical fiber LF.

The driving substrate DSB may be connected to the laser light source LS to provide a power signal to the laser light source LS. In an embodiment, the driving substrate DSB may perform a heat dissipation function.

The driving substrate DSB is disposed inside the bottom chassis BC, e.g., in the accommodation space of the bottom chassis BC. The driving substrate DSB may be disposed on, e.g., fixed to, the sidewall BW. In an embodiment of the inventive concept, the backlight unit 200 may further include an adhesive ADH for allowing the driving substrate DSB to adhere to the sidewall BW. The adhesive ADH may include an optical clear adhesive (“OCA”) or an optical clear resin (“OCR”).

The driving substrate DSB may include a base substrate MSB and a line layer LNI.

The base substrate MSB may include or be formed of a metal having high thermal conductivity. The line layer LNI may be disposed on the base substrate MSB and include circuits and/or lines for the driving of the laser light source LS. The circuits and/or lines of the line layer LNI may be insulated from the base substrate MSB.

In such an embodiment, the base substrate MSB of the driving substrate DSB includes or is formed of the metal such that the driving substrate DSB may release heat generated from a laser light source LS.

The laser light source LS may emit laser light to the sidewall BW. In an embodiment, the laser light source LS may emit laser light in a direction parallel to the bottom surface BP.

The optical unit LU may guide the light emitted from the laser light source LS to emit the light to the optical fiber LF. The optical unit LU may have an incident surface LU1 and an emission surface LU2. The incident surface LU1 may have a first area, and the emission surface LU2 may have a second area less than the first area.

The optical fiber LF may have one end connected to the emission surface LU2. The optical fiber LF may extend in parallel to the bottom surface BP. The laser light emitted from the emission surface LU2 may proceed to the other end of the optical fiber LF within the optical fiber LF.

Recessed patterns GV may be defined or provided in the optical fiber LF. The laser light proceeding within the optical fiber LF may be emitted to the display panel 100 through the recessed patterns GV.

A detailed description of the light source part LSP will be described later.

The diffusion plate DFS may be disposed on the bottom chassis BC. The diffusion plate DFS may be supported by the sidewall BW. The diffusion plate DFS may uniformly diffuse the laser light emitted to an outside the optical fiber LF through the recessed patterns GV. In an embodiment, the diffusion plate DFS may disperse the light incident from the light source part LSP to effectively prevent the light from being locally concentrated.

The optical sheets OPS may be disposed on the diffusion plate DFS. The optical sheets OPS may include a diffusion sheet OPS1, a light collection sheet OPS2, and a protection sheet OPS3. The diffusion sheet OPS1 may diffuse the light incident thereto. The light collection shaft OPS2 may increase luminance of the diffused light. The protection sheet OPS3 may protect the light collection sheet OPS2 and secure a viewing angle. In an embodiment of the inventive concept, as shown in FIG. 2, the optical sheets OPS may include three sheets, but an embodiment of the inventive concept is not limited thereto. In one alternative embodiment, for example, the optical sheets OPS may include four sheets. In another alternative embodiment, the optical sheets OPS may be constituted by the light collection sheet OPS and the protection sheet OPS3 except for the diffusion sheet OPS1.

The middle mold MF may support the display panel 100. The middle mold MF may be coupled to the bottom chassis BC. The middle mold MF may include a first middle mold portion MF1 and a second middle mold portion MF2. The first middle mold portion MF1 may extend along the sidewall BW. The first middle mold portion MF1 may have a rectangular loop shape. The second middle mold portion MF2 may protrude in parallel to the bottom surface BP from the first middle mold portion MF1 toward the inside of the first middle mold portion MF1 or integrally formed as a single unitary and indivisible unit. The first and second middle mold portions MF1 and MF2 may be integrated with each other. According to an alternative embodiment of the inventive concept, the middle mold MF and the bottom chassis BC may be integrated with each other or integrally formed as a single unitary and indivisible unit.

In an embodiment, as shown in FIG. 2, the second middle mold MF2 may be disposed between the diffusion plate DFS and the optical sheets OPS, and the diffusion plate DFS and the optical sheets OPS may be spaced apart from each other in the third direction DR3. However, an embodiment of the inventive concept is not limited thereto. In one alternative embodiment, for example, the second middle mold MF2 may be disposed between the optical sheets OPS and the display panel 100, and the optical sheets OPS and the display panel 100 may be spaced apart from each other in the third direction DR3.

The backlight unit 200 may further include a support SPT. The support SPT may be disposed between the bottom surface BW and the optical fiber LF to support the optical fiber LF.

The top chassis 300 may cover an edge of the display panel 100 and be coupled to the display panel 100 and the backlight unit 200. The top chassis 300 may have an opening WD through which the display area DA of the display panel 100 is exposed.

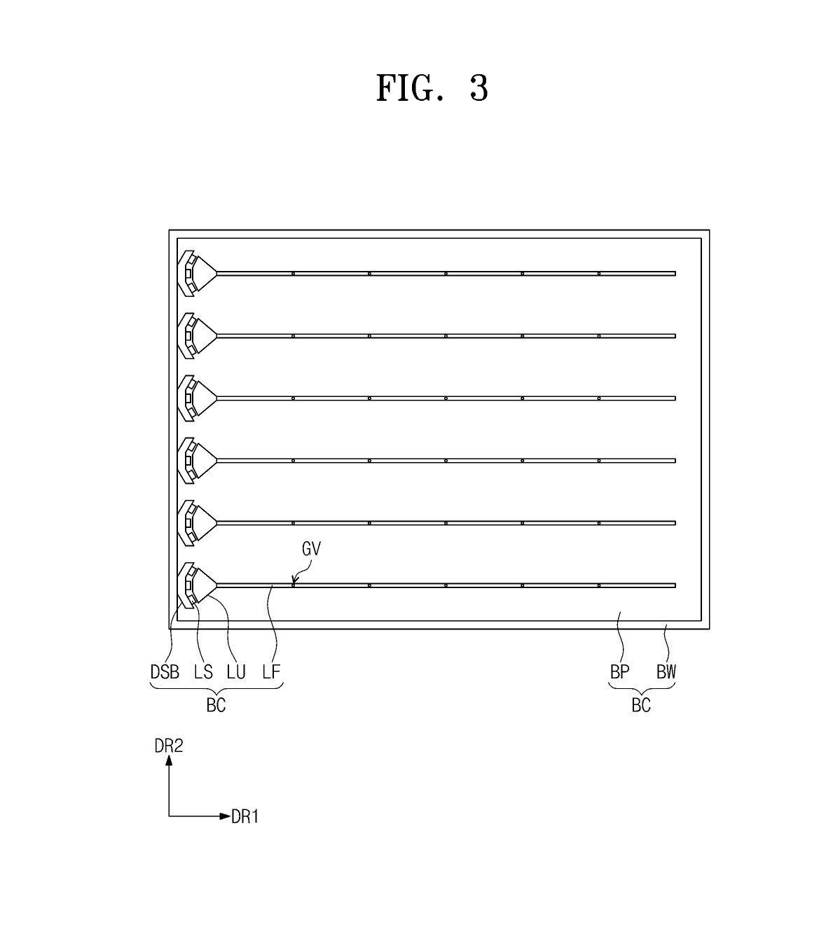

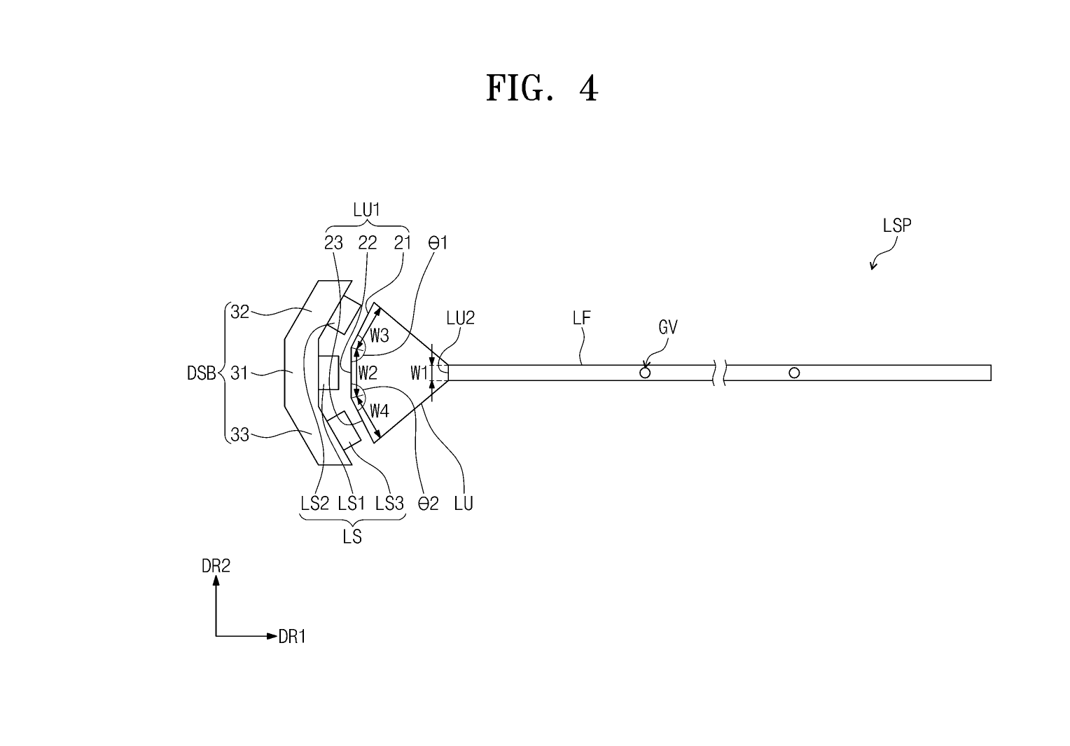

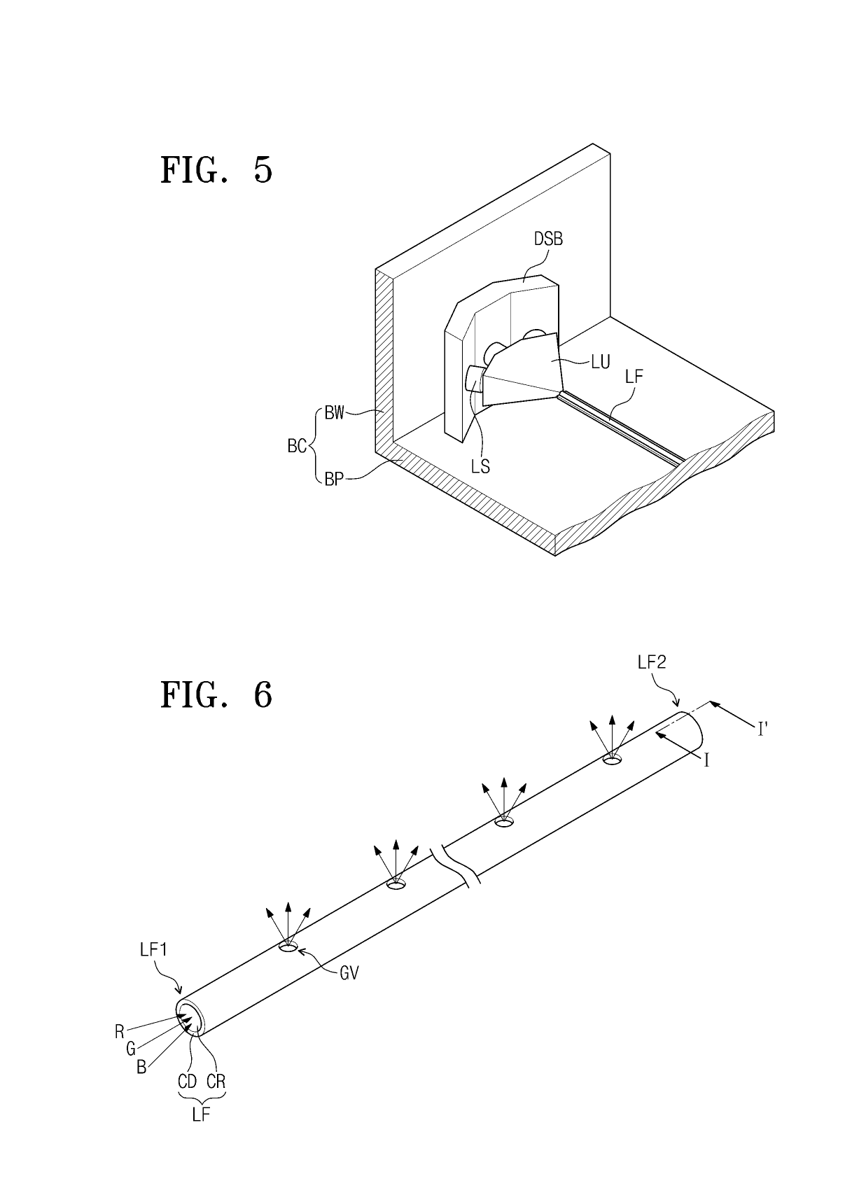

FIG. 3 is a plan view of a bottom chassis and a light source part according to an embodiment of the inventive concept, FIG. 4 is a plan view of an embodiment of a light source part, and FIG. 5 is a perspective view of an embodiment of a light source part.

The light source part LSP will be described in greater detail with reference to FIGS. 2 to 5.

The light source part LSP may be provided in plurality. The plurality of light source parts LSP are disposed adjacent to each other in the second direction DR2.

The incident surface LU1 of the optical unit LU may include first to third incident surfaces 21, 22, and 23.

The first incident surface 21 may be parallel to an inner surface of the sidewall BW to which the driving substrate DSB is fixed. The second incident surface 22 may inclinedly extend with respect to the first incident surface 21 from one side of the first incident surface 21. An internal angle θ1 of the optical unit LU, which is defined by the first and second incident surfaces 21 and 22 may be less than about 180°.

The third incident surface 23 may inclinedly extend with respect to the first incident surface 21 from the other side of the first incident surface 21. An internal angle θ1 of the optical unit LU, which is defined by the first and third incident surfaces 21 and 23 may be less than about 180°.

The emission surface LU2 of the optical unit LU may have a first height, and the incident surface LU1 may have a second height. The first height may be less than the second height. Herein, height is defined as a length in the third direction DR3.

The emission surface LU2 may have a first width W1, which is a length thereof in the second direction DR2, and the incident surface LU1 may have a second width, which is a length thereof in the direction parallel to the bottom surface BP. The second width may be defined by the sum of widths W2, W3 and W4 of the first to third incident surfaces 21, 22, and 23. The second width may be greater than the first width W1.

The driving substrate DSB may have a curved shape that is symmetrical to each other in the first direction DR1 to correspond to the shape of the incident surface LU1.

The driving substrate DSB may include a flat portion 31, a first inclined portion 32, and a second inclined portion 33.

The flat portion 31 may face the first incident surface 21 and extend in parallel to the first incident surface 21.

The first inclined portion 32 may extend from one side of the flat portion 31. The first inclined portion 32 may face the second incident surface 22 and extend in parallel to the second incident surface 22.

The second inclined portion 33 may extend from the other side of the flat portion 31. The second inclined portion 33 may face the third incident surface 23 and extend in parallel to the third incident surface 33.

A distance between the flat portion 31 and the first incident surface 21, a distance between the first inclined portion 32 and the second incident surface 22, and a distance between the second inclined portion and the third incident surface 23 may be the same as each other.

The flat portion 31, the first inclined portion 32, and the second inclined portion 33 may be integrated with each other or integrally formed as a single unitary and indivisible unit.

The laser light source LS may include first to third laser lights LS1, LS2, and LS3.

The first laser light source LS1 may be disposed or mounted on the flat portion 31, the second laser light source LS2 may be disposed or mounted on the first inclined portion 32, and the third laser light source LS3 may be disposed or mounted on the second inclined portion 33.

A forward emission direction of the first laser light source LS1 may be perpendicular to the first incident surface 21, a forward emission direction of the second laser light source LS2 may be perpendicular to the second incident surface 22, and a forward emission direction of the third laser light source LS3 may be perpendicular to the third incident surface 23.

The first to third laser light sources LS1 to LS3 may emit laser light having colors different from each other. In one embodiment, for example, the first laser light source LS1 may emit a red laser light, the second laser light source LS2 may emit a green laser light, and the third laser light source LS3 may emit a blue laser light.

The red, green, and blue laser light emitted from the first to third laser light sources LS1 to LS3 may be totally reflected within the optical unit LU and then guided to the emission surface LU2. The red, green, and blue laser lights may be mixed with each other to realize a white color.

FIG. 6 is a perspective view of an embodiment of the optical fiber.

Referring to FIGS. 2, to 6, the optical fiber LF may include a core CR and a cladding CD.

The core CR may include or be formed of a transparent material. The cladding CD may surround the core CR. The core CR may include or be formed of a material having a refractive index greater than that of the cladding CD. Thus, the red, green, and blue light R, G, B may proceed within the core CR.

The recessed patterns GV may be defined by openings defined or formed through the cladding CD or a removed portion of the cladding CD. The core CR may be exposed through the openings of the cladding CD that define the recessed patterns GV. The recessed patterns GV may be disposed to face the display panel 100. The laser light proceeding within the core CR may not satisfy the total reflection condition when reaching the recessed patterns GV and thus be emitted to an outside of the optical fiber LF through the recessed patterns GV. The laser light emitted through the recessed patterns GV may be provided to the display panel 100.

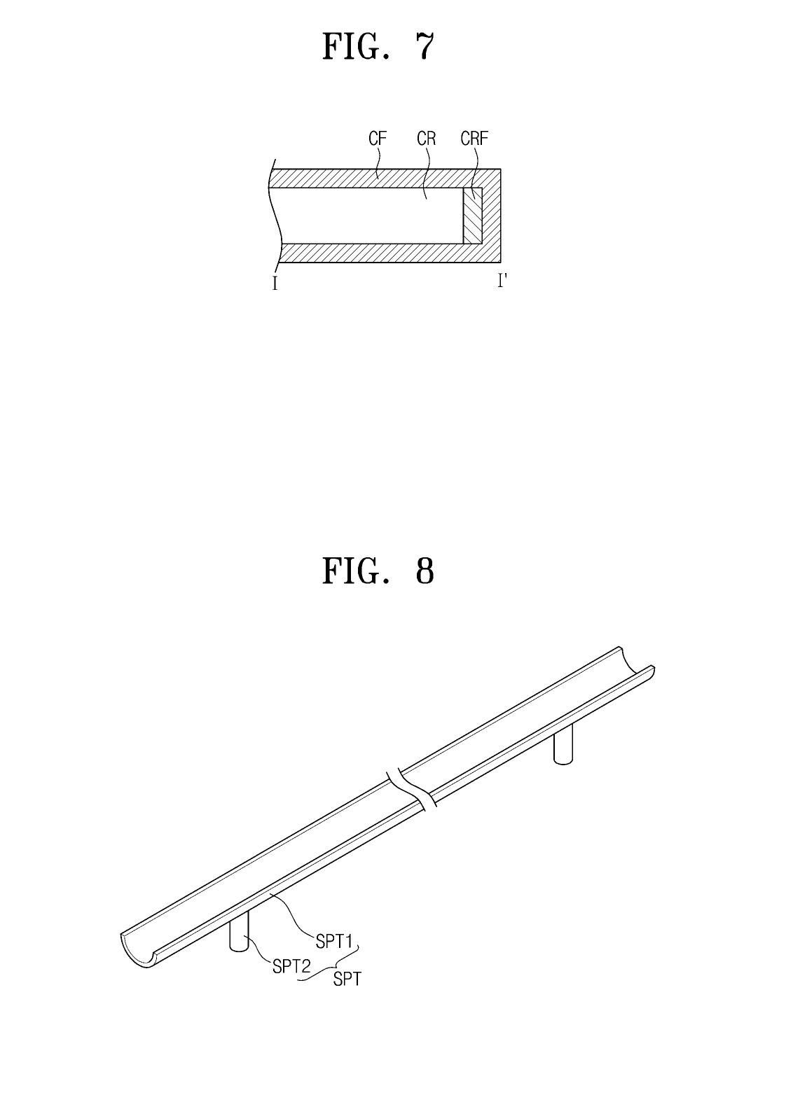

FIG. 7 is a cross-sectional view taken along line I-I′ of FIG. 6.

The optical fiber LF may further include a reflection layer CRF disposed between the core CR and the cladding CD at an end thereof. The reflection layer CRF may be disposed to face the optical unit LU and the emission surface LU2.

The red, green, and blue laser light R, G, and B which are incident into the end LF1 of the optical fiber LF may be guided within the core CR to proceed to an opposite end LF2 of the optical fiber LF. The red, green, and blue laser light R, G, and B reaching the opposite end LF2 of the optical fiber LF may be reflected by the reflection layer CRF to proceed back to the end LF1 of the optical fiber LF.

FIG. 8 is a perspective view of the support of FIG. 2.

Referring to FIGS. 2 and 8, the support SPT may include an upper support member SPT1 and a fixed member SPT2.

The upper support member SPT1 may support the optical fiber LF. The upper support member SPT1 may have a shape of a cylindrical tube cut in half in a longitudinal direction. The fixed member SPT2 may be fixed to the bottom surface BP to support the upper support member SPT1.

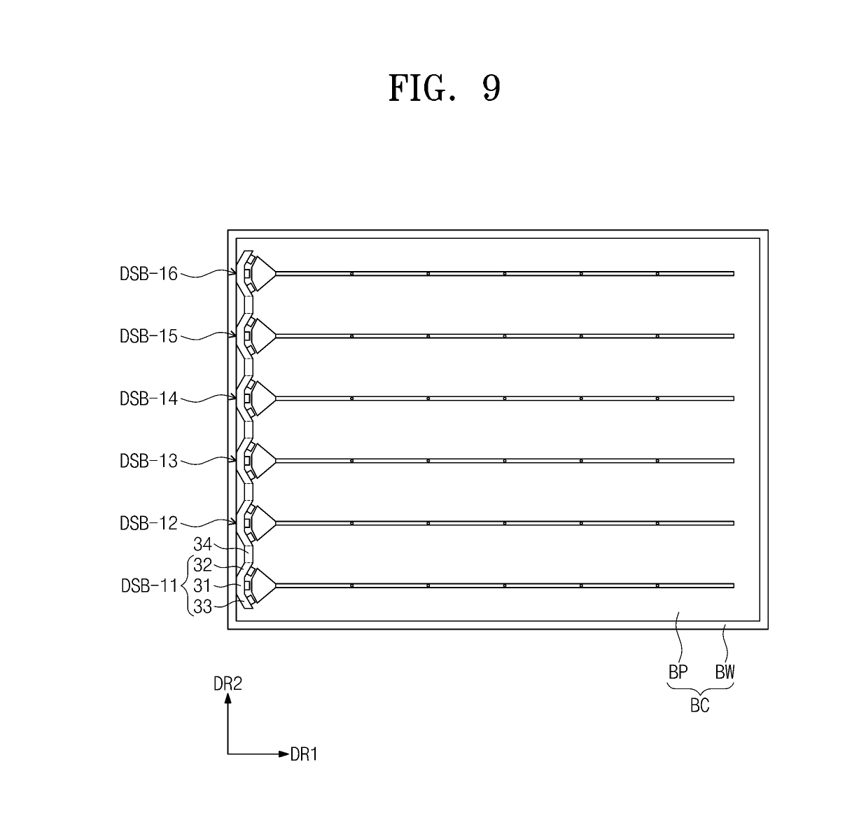

FIG. 9 is a plan view of a bottom chassis and a light source part according to an alternative embodiment of the inventive concept.

The bottom chassis and the light source part in FIG. 9 is substantially the same as those shown in FIG. 3 except for the driving substrate DSB-1. The same or like elements shown in FIG. 9 have been labeled with the same reference characters as used above to describe embodiments of the bottom chassis and the light source part shown in FIG. 3, and any repetitive detailed description thereof will hereinafter be omitted or simplified.

In an embodiment, as shown in FIG. 9, the driving substrate DSB-1 may include a plurality of driving substrates DSB-11 to DSB-16. For example, sixth driving substrates DSB-11 to DSB-16 are illustrated in FIG. 8. Each of the plurality of driving substrates DSB-11 to DSB-16 may be divided into a flat portion 31, a first inclined portion 32, and a second inclined portion 33.

A backlight unit 200 may further include connection substrates 34 connecting the plurality of driving substrates DSB-11 to DSB-16 to each other. Each of the connection substrates 34 may extend in parallel to a first incident surface 21. The connection substrates 34 may be further spaced apart from a sidewall BW than the flat portion 31.

The plurality of driving substrates DSB-11 to DSB-16 and the connection substrates 34 may be provided as one substrate. The plurality of driving substrates DSB-11 to DSB-16 and the connection substrates 34 may be integrated with each other or integrally formed as a single unitary and indivisible unit. Thus, lines for providing power to at least four laser light sources LS may be shared with each other.

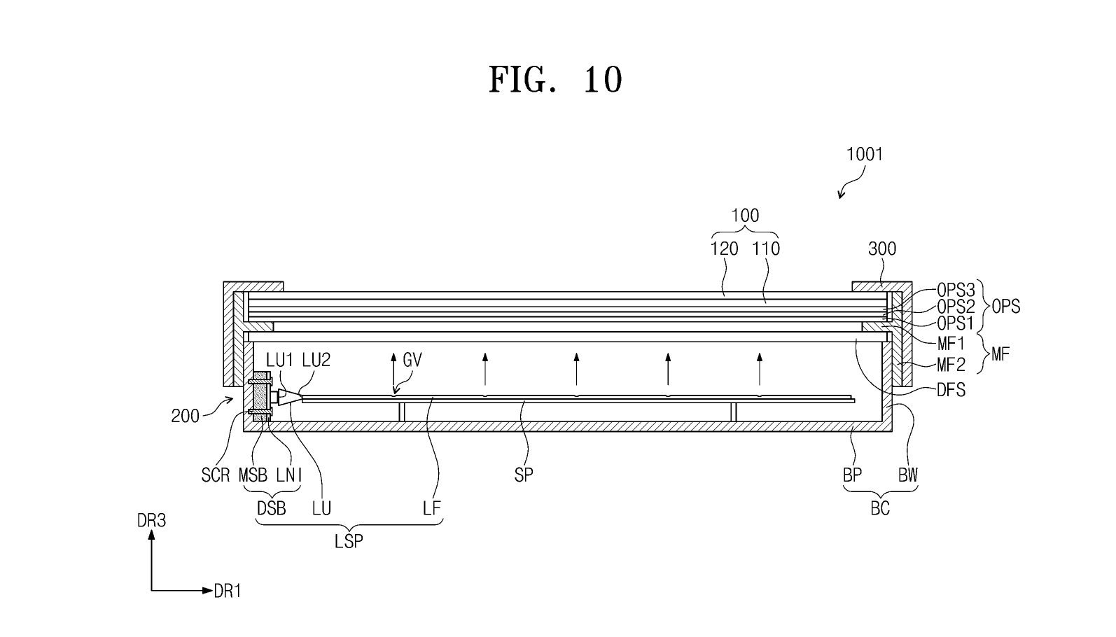

FIG. 10 is a sectional view of a display apparatus according to an alternative embodiment of the inventive concept.

A display apparatus 1001 illustrated in FIG. 10 is substantially the same as the display apparatus 1000 illustrated in FIG. 2 except for a coupling method of the driving substrate DSB. The same or like elements shown in FIG. 10 have been labeled with the same reference characters as used above to describe embodiments of the display apparatus 1000 illustrated in FIG. 2, and any repetitive detailed description thereof will hereinafter be omitted or simplified

In an embodiment, as shown in FIG. 10, the backlight unit 200 may further include a screw SCR. The screw SCR may pass through the driving substrate DSB and then be coupled to the sidewall BW. The driving substrate DSB may be coupled to the sidewall BW by the screw SCR.

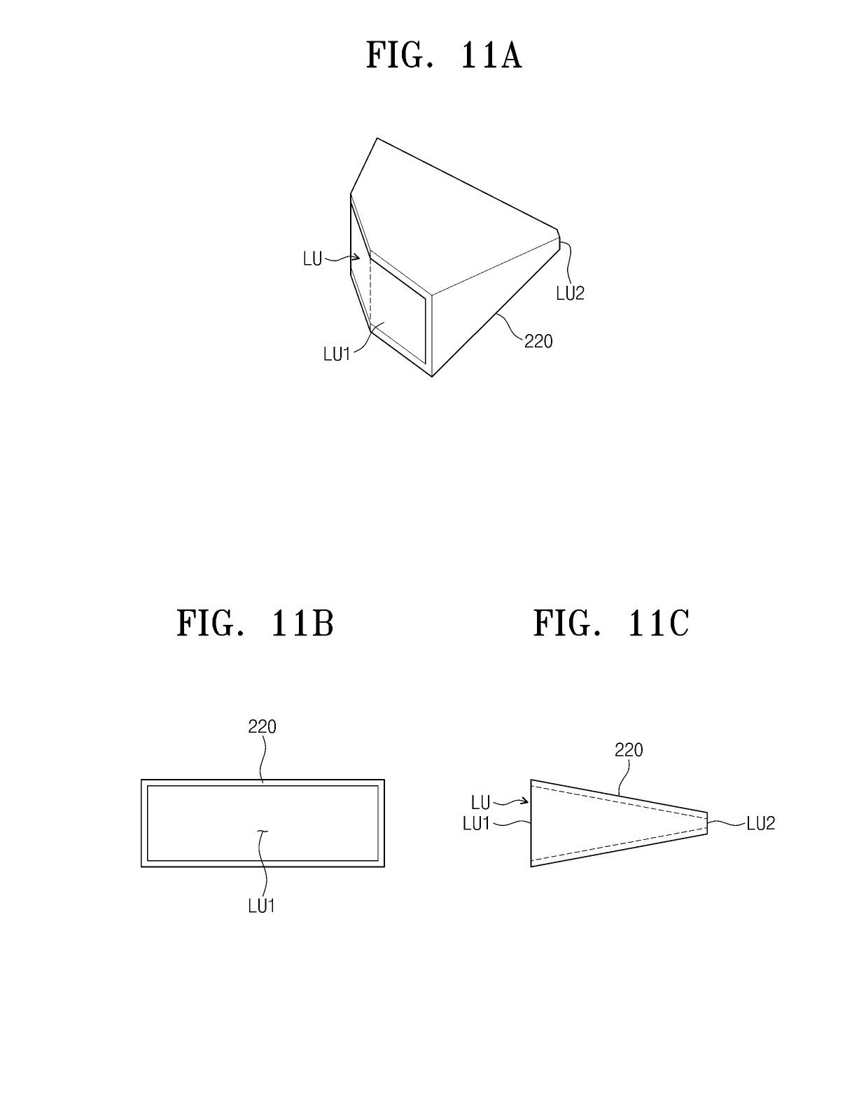

FIG. 11A is a perspective view of an optical unit and a reflection layer according to another alternative embodiment of the inventive concept, FIG. 11B is a front view of the optical unit and the reflection layer shown in FIG. 11A, and FIG. 11C is a side view of the optical unit and the reflection layer shown in FIG. 11A.

Referring to FIGS. 11A to 11C, an embodiment of the backlight unit may further include a reflection layer 220. The reflection layer 220 may be disposed to surround side surfaces of an optical unit LU except for an incident surface LU1 and an emission surface LU2 of the optical unit LU. The reflection layer 220 may expose the incident surface LU1 and the emission surface LU2. The reflection layer 220 may include or be formed of a material capable of reflecting light incident thereto. The reflection layer 220 may improve reflection efficiency of laser light proceeding within the optical unit LU to reduce a light loss of the laser light.

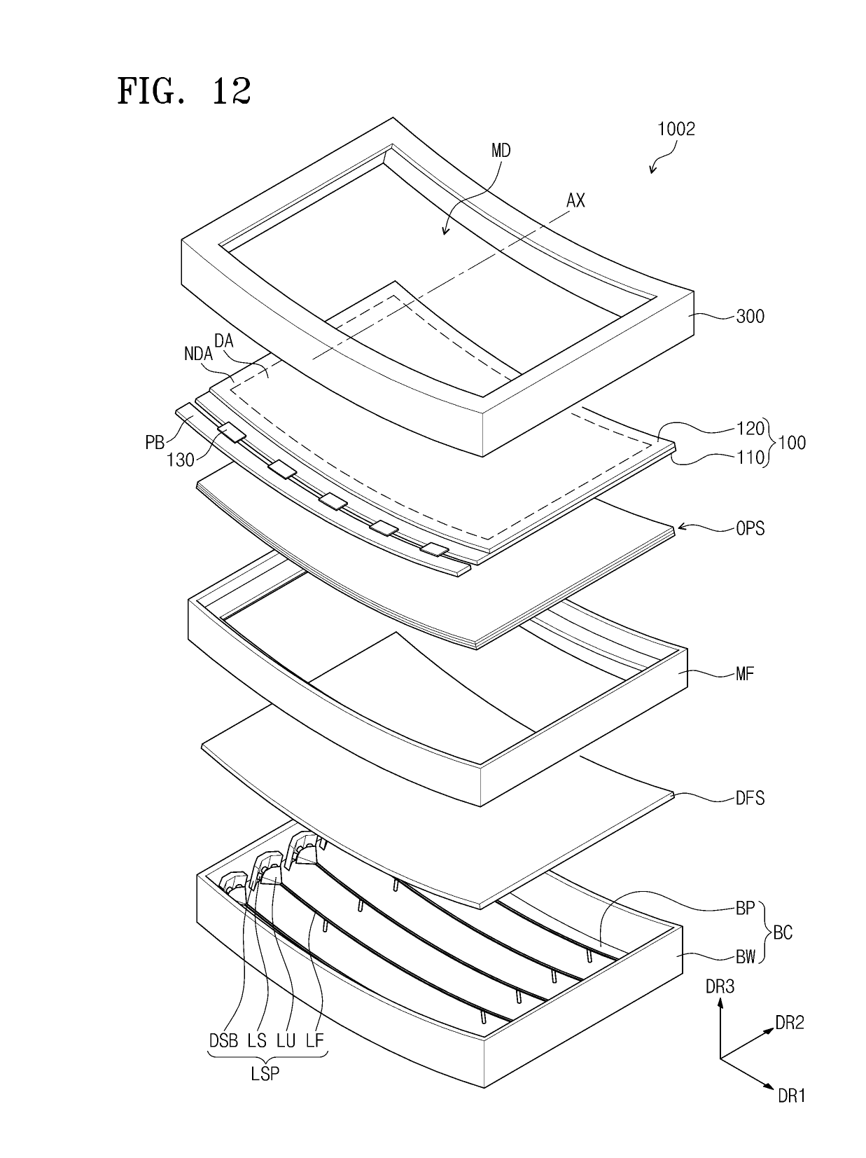

FIG. 12 is an exploded perspective view of a display apparatus according to another alternative embodiment of the inventive concept.

Referring to FIG. 12, a display apparatus 1002 may have a curved shape.

In an embodiment, as shown in FIG. 12, the display apparatus 1002 may have a shape that is curved on the basis of a reference axis AX. The optical fiber LF may have a shape that is curved on the basis of the reference axis AX. In FIG. 12, the reference axis AX may extend in the second direction DR2.

All of the display panel 100, the backlight unit 200, and the top chassis 300 may be shapes that are curved on the basis of the reference axis AX.

Since the optical fiber LF has flexibility, the optical fiber LF may be easily curved. In such an embodiment, where the display apparatus 1002 includes the optical fiber LF, the display apparatus 1002 may be easily curved.

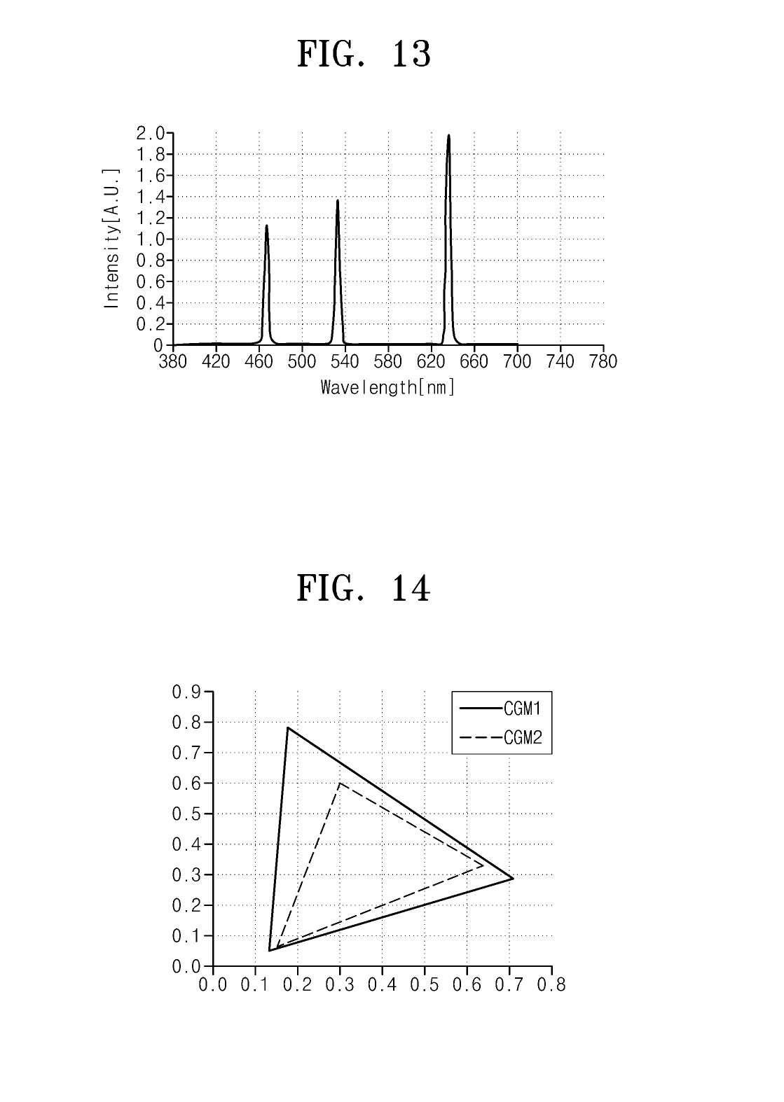

FIG. 13 is a view illustrating intensities of the red, green, and blue laser light depending on wavelengths of the laser light.

Referring to FIG. 13, each of a full width at half maximum (“FWHM”) of red laser light, a FWHM of green laser light, a FWHM of blue laser light may be about 4 nanometers (nm).

Blue light emitted from a light emitting diode may have a FWHM of about 20 nm, green light may have a FWHM of about 50 nm, and red light may have a FWHM of about 100 nm.

Each of the red, green, and blue laser light may have a FWHM less than that of each of the red, green, and blue light emitted from the light emitting diode.

FIG. 14 is a view of color spaces that are capable of being realized in the display apparatus adopting various light sources in a CIE1931 color space.

FIG. 14 illustrates first and second color spaces CGM1 and CGM2. The first color space CGM1 may be a color space that is capable of being realized in the display apparatus adopting the laser light source as the light source according to an embodiment of the inventive concept. The second color space CGM2 may be a color space that is capable of being realized in a display apparatus (Comparative Example) adopting the light emitting diode (“LED”) as the light source.

The first color space CGM1 may have an area greater than that of the second color space CGM2.

As described with reference to FIG. 13, the laser light may have a very small FWHM. In an embodiment of the inventive concept, as described above, the display apparatus may adopt the laser light as the light source to improve color gamut when compared to that of the display apparatus according to Comparative Example.

In an embodiment of the backlight unit and the display apparatus according to the inventive concept, the color gamut of the image may be improved.

The modifications or changes made without departing from the spirit and scope of the inventive concept are evident to a person having ordinary skill in the art to which the inventive concept pertains. Hence, all changes, modifications, or alterations should therefore be seen as within the scope of the invention.

What is claimed is:

1. A display apparatus comprising:
a display panel which displays an image; and
a backlight unit which provides light to the display panel,
wherein the backlight unit comprises:
a bottom chassis comprising a bottom surface and a sidewall bent from the bottom surface;
a driving substrate disposed in the bottom chassis;
a laser light source connected to the driving substrate and which emits laser light;
an optical unit comprising an incident surface having a first area, and an emission surface having a second area less than the first area, wherein the laser light emitted from the laser light source is incident into the incident surface, and the laser light is emitted from the emission surface; and
an optical fiber which receives the laser light emitted from the optical unit, wherein an end of the optical fiber is connected to the emission surface, recessed patterns are defined on the optical fiber, and the laser light is emitted through the recessed patterns.

2. The display apparatus of claim 1, wherein
the laser light source comprises first to third laser light sources,
wherein each of the first to third laser light sources emits the laser light to the incident surface.

3. The display apparatus of claim 2, wherein
the first laser light source emits a red laser light,
the second laser light source emits a green laser light, and
the third laser light source emits a blue laser light.

4. The display apparatus of claim 2, wherein the incident surface comprises:
a first incident surface parallel to an inner surface of the sidewall;
a second incident surface extending from a side of the first incident surface at an first internal angle of the optical unit with the first incident surface, wherein the first internal angle is less than about 180°; and
a third incident surface extending from another side of the first incident surface at an second internal angle of the optical unit with the first incident surface, wherein the second internal angle is less than about 180°.

5. The display apparatus of claim 4, wherein the driving comprises:
a flat portion extending in parallel to the first incident surface and on which the first laser light source is disposed;
a first inclined portion extending in parallel to the second incident surface from a side of the flat portion and on which the second laser light source is disposed; and
a second inclined portion extending in parallel to the third incident surface from another side of the flat portion and on which the third laser light source is disposed,
wherein a distance between the flat portion and the first incident surface, a distance between the first inclined portion and the second incident surface, and a distance between the second inclined portion and the third incident surface are the same as each other.

6. The display apparatus of claim 4, wherein
the driving substrate comprises first and second driving substrates,
the first to third laser light sources are disposed on each of the first and second driving substrates,
the optical fiber extends in a first direction, and
the first and second driving substrates are spaced apart from each other in a second direction crossing the first direction.

7. The display apparatus of claim 6, wherein the recessed patterns defined in the optical fiber are spaced apart from each other in the first direction.

8. The display apparatus of claim 6, wherein the backlight unit further comprises a connection substrate which connects the first and second driving substrates to each other and extends in parallel to the first incident surface.

9. The display apparatus of claim 8, wherein the first and second driving substrates and the connection substrate are integrated with each other.

10. The display apparatus of claim 1, wherein the optical fiber comprises:
a core through which the laser light proceeds; and
a cladding surrounding the core,
wherein the recessed patterns are defined by openings defined in the cladding, and
the core is exposed through the openings in the recessed patterns.

11. The display apparatus of claim 1, wherein
a height of the emission surface in a direction perpendicular to the bottom surface is less than a height of the incident surface in the direction perpendicular to the bottom surface, and
a width of the emission surface in a direction parallel to the bottom surface is less than a width of the incident surface in the direction parallel to the bottom surface.

12. The display apparatus of claim 1, wherein the driving substrate is fixed to the sidewall.

13. The display apparatus of claim 12, wherein the driving substrate comprises:
a base substrate comprising a metal, wherein the base substrate is fixed to the sidewall; and
a line layer disposed on the base substrate, wherein the line layer comprises circuits and lines for driving the laser light source.

14. The display apparatus of claim 12, wherein the backlight unit further comprises an adhesive which couples the driving substrate to the sidewall.

15. The display apparatus of claim 12, wherein the backlight unit further comprises a screw disposed to pass through the driving substrate and coupled to the sidewall.

16. The display apparatus of claim 1, wherein
the backlight unit further comprises a support disposed between the optical fiber and the bottom surface,
wherein the support supports the optical fiber.

17. A backlight unit comprising:
a bottom chassis comprising a bottom surface and a sidewall bent from the bottom surface;
a driving substrate disposed in the bottom chassis;
a laser light source connected to the driving substrate and which emits laser light to the sidewall;
an optical unit comprising an incident surface having a first area and an emission surface having a second area less than the first area, wherein the laser light emitted from the laser source is incident into the incident surface, and the laser light is emitted from the emission surface; and
an optical fiber which receives the laser light emitted from the emission surface, wherein an end of the optical fiber is connected to the emission surface, recessed patterns are defined on the optical fiber, and the laser light is emitted through the recessed patterns.

18. The backlight unit of claim 17, wherein
the laser light source comprises first to third laser light sources,
wherein each of the first to third light sources emits the laser light to the incident surface.

19. A display apparatus comprising:
a display panel which displays an image, wherein the display panel is curved on the basis of a reference axis; and
a backlight unit which provides light to the display panel, wherein the backlight unit is curved on the basis of the reference axis,
wherein the backlight unit comprises:
a bottom chassis comprising a bottom surface and a sidewall bent from the bottom surface;
a driving substrate disposed in the bottom chassis;
a laser light source connected to the driving substrate and which emits laser light to the sidewall;
an optical unit including an incident surface having a first area and an emission surface having a second area less than the first area, wherein the laser light emitted from the laser light source is incident into the incident surface, and the laser light is emitted from the emission surface; and
an optical fiber curved on the basis of the reference axis and which receives the laser light emitted from the emission surface, wherein an end of the optical fiber is connected to the emission surface, recessed patterns are defined on the optical fiber, and the laser light is emitted through the recessed patterns.
